(19) United States
(12) Patent Application Publication
(10) Pub. No.: US 2004/0253401 A1
(43) Pub. Date: Dec. 16, 2004

(54) Housing including integrated indicia and method of making

(76) Inventors: Steven Duane Pratt, Ft. Lauderdale, FL (US); Robert W. Pennisi, Boca Raton, FL (US); Fadia Nounou, Plantation, FL (US); Ronald James Kelley, Plantation, FL (US); Sivakumar Muthuswamy, Plantation, FL (US)

Correspondence Address: Randi L. Dulaney, Motorola, Inc., Law Department, 8000 West Sunrise Boulevard, Fort Lauderdale, FL, 33322, US

(21) Appl. No.: 10/460,134

(22) Filed: Jun. 12, 2003

(51) Int. Cl. B32B 1/02; B23K 26/36

(52) U.S. Cl. 428/35.7; 219/121.69

(57) ABSTRACT

A compound curved shaped housing part (104) includes integrated activatable electrochromic indicia (114, 116, 118, 120). The indicia are formed by coating an internal surface (302) of a transparent plastic shell (402) with a sequence of layers including: optionally a separate transparent conductor (408), an electrochromic material layer (410), an electrolyte layer (412), optionally a separate ion donor layer (414), optionally an insulator layer 418 and a second conductive layer. Laser etching is used to provide access to the transparent conductor layer. The insulator layer is patterned to provide access for electrodes to underlying layers. Laser etching is used to pattern the second conductive layer to define interconnected electrodes (322-332), traces (314-318), and electrical contacts (304-312).

### BACKGROUND OF THE INVENTION

1. Field of the Invention

The present invention relates in general to activatable indicia. More particularly, the present invention relates to activatable indicia for portable electronic devices.

2. Description of Related Art

The capabilities of wireless communication devices such as consumer cellular network telephones have continually increased and continue to do so. Presently, the additional functionality that portable wireless communication devices have acquired include the ability to browse the World Wide Web, play music, and take, send and receive photos. As more functionality is added to portable wireless communication devices, increased demands are made on the parts of the devices, such as the keypad, and the display that make up the user interface. The user interface is somewhat constrained by the small size of typical portable wireless devices. In order to get the most out of small size portable wireless devices, it is desirable to maximize the utilization of parts of portable wireless devices, for user interface functions.

### BRIEF DESCRIPTION OF THE FIGURES

The present invention will be described by way of exemplary embodiments, but not limitations, illustrated in the accompanying drawings in which like references denote similar elements, and in which:

FIG. 1 is a front view of a wireless communication device according to the preferred embodiment of the invention;

FIG. 2 is a cross sectional side view of the wireless communication device shown in FIG. 1;

FIG. 3 is a view of an inside surface of a front part of a housing of the wireless communication device shown in FIG. 1;

FIG. 4 is a first fragmentary perspective view of the front housing part shown in FIGS. 1-3;

FIG. 5 is a second fragmentary perspective view of the front housing part shown in FIGS. 1-3;

FIG. 6 is a flow chart of a method of fabricating electrochromic activatable indicia in the front housing part shown in FIGS. 1-5; and

FIG. 7 is a schematic diagram of a laser etching apparatus for use in the method shown in FIG. 5 according to the preferred embodiment of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

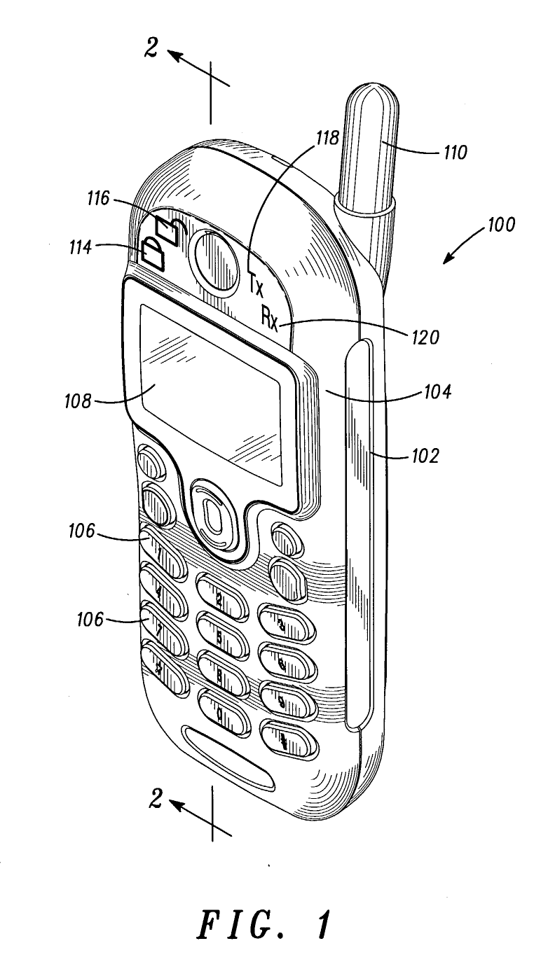

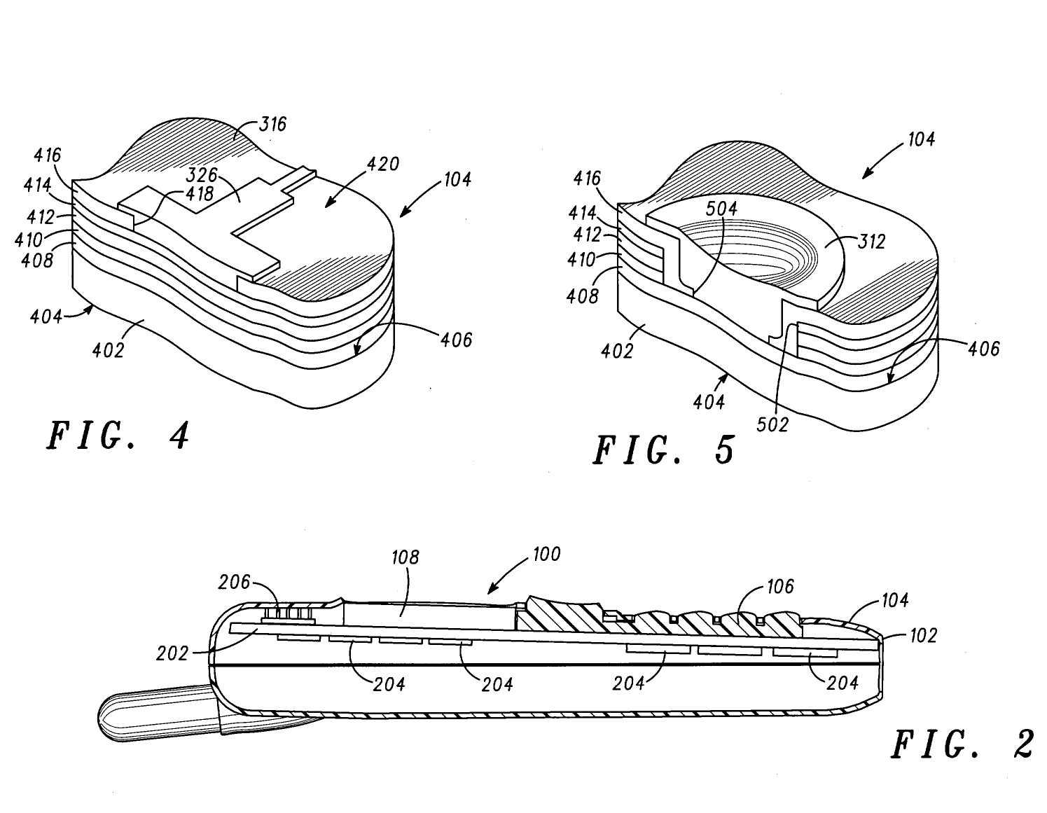

FIG. 1 is a front view of a wireless communication device 100 according to the preferred embodiment of the invention and FIG. 2 is a cross sectional side view of the wireless communication device 100 shown in FIG. 1. The wireless communication device 100 comprises a housing 102 including a front housing portion 104. The housing 102 supports and mechanically couples a plurality of components that comprise the wireless communication device 100, including a plurality of keys 106, a display screen 108, an antenna 110, and a circuit board 202. The circuit board 202 supports and interconnects a plurality of electrical components 204 that make up one or more electrical circuits of the wireless device 100.

The front housing portion 104 includes a plurality of electrochromic indicia including a locked lock graphic icon 114, an open lock graphic icon 116, a first abbreviated text ‘Tx’ indicia, 118 and a second abbreviated text ‘Rx’ indicia 120. The electrochromic indicia 114-120 are used to communicate operating status information to users of the wireless communication device 100. Although four particular indicia 114-120 are shown, the electrochromic indicia can be made to present other icon or textual information. For example, an icon indicating that a new message has been received is alternatively provided.

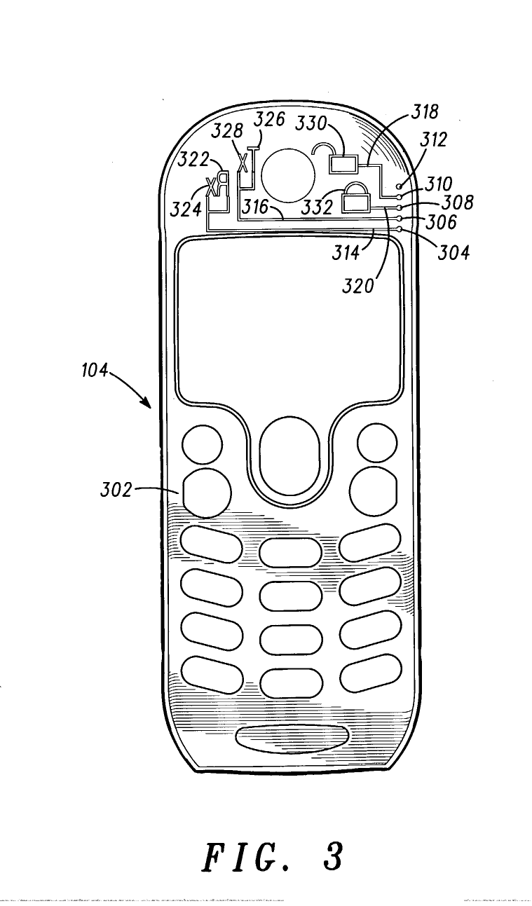

FIG. 3 is a view of an inside surface 302 of the front housing part 104 of the wireless communication device 100 shown in FIG. 1. The front housing part 104 is preferably made of transparent plastic and the electrochromic indicia 114-120 are preferably formed at the inside surface 302 of the front housing portion 104. The front housing part, 104, including the inside surface 302 preferably, in view of ergonomic and design considerations, has a compound curve shape. The inside surface 302, in particular is preferably a compound curve surface. Forming display elements on a compound curve surface presents a challenge that is addressed in embodiments described below.

A plurality of electrical contacts including a first 304, a second 306, a third 308, a fourth 310 and a fifth 312 electrical contact are provided on the inside surface 302 of the front housing part 104. The first electrical contact 304 is connected through a first forked trace 314 to a first electrode 322, and a second electrode 324 for the letters ‘R’ and ‘x’ of the ‘Rx’ indicia 120. Similarly, the second electrical contact 306 is connected through a second forked trace 316 to a third electrode 326, and a fourth electrode 328 for the letter ‘T’ and ‘x’ of the ‘Tx’ indicia 118. The third 308 and fourth 310 electrical contacts are connected via a third 318 and a fourth 320 conductive trace respectively to a fifth electrode 330 for the open lock graphic icon 116, and a sixth electrode 332 for the locked lock graphic icon 114. The fifth electrical contact is 312 is electrically connected to an underlying transparent conductive layer 408 (FIG. 4). An elastomeric connector 206 shown in FIG. 2 connects the contacts 304-312 to driver circuits on the circuit board 202. Driver circuits are embodied in the electrical components 204.

FIG. 4 is a first fragmentary perspective view of the front housing part 104 shown in FIGS. 1-3, that includes the third electrode 326 for the letter ‘T’. The front housing part 104 includes a transparent plastic shell 402, which is preferably injection molded out of a plastic material such as polycarbonate, Acrylonitrile Butadiene Styrene (ABS) or mixtures thereof. A first surface 404 of the transparent plastic shell 402 faces the outside of the wireless communication device 100, and a second inside surface 406 of the plastic shell 402 faces the inside of the wireless communication device 100. A plurality of layers as described below are stacked on the inside surface 406 of the plastic shell 402. A first transparent conductive layer 408 is formed on the inside surface 406. The transparent conductive layer 408 preferably comprises a transparent conductive polymer such as poly 3,4-ethylenedioxythiophene (PEDOT). Alternatively, for example, the conductive layer 408 comprises indium tin oxide (ITO).

A second electrochromic material layer 410 is formed on the transparent conductive layer 408. The electrochromic material layer 410 preferably comprises an organic electrochromic material, such as polyaniline, plycarbazole, polypyrrole, plythiophene. Alternatively, the electrochromic material layer comprises an inorganic material layer such as tungsten trioxide (WO₃), or molybdenum trioxide (MoO₃). According to an alternative embodiment of the invention, a single material layer that is both conductive and exhibits electrochromism is used in place of the transparent conductive layer 408, and the electrochromic layer 410.

A third electrolyte layer 412 is formed on the electrochromic material layer 410. The electrolyte layer 412 preferably comprises a solid polymer including a dispersed salt compound. One example of a polymer that is suitable for use in electrolyte layer 412 is the copolymer of ethylene oxide and epichlorohydrin, including a dispersed ionic compound. The latter is produced by Daiso Co. Ltd of Osaka, Japan. Alternatively, the electrolyte layer 412 comprises a gel electrolyte layer.

An ion donor layer 414 is formed on the electrolyte layer 412. The ion donor layer preferably comprises a metal oxide such as Li_{1.2}V₂O₅. Alternatively, the ion donor layer 404 is also electrochromic, but exhibits an electrochromic color change that is complementary to that exhibited by electrochromic material layer 410.

A patterned insulator layer 416 is formed over the ion donor layer 414. The patterned insulator layer 416 includes openings such as a first opening 418 shown in FIG. 4, through which electrodes, such as the third electrode 326 make contact with the underlying ion donor layer 414. The first opening 418 has a letter ‘T’ shape, that defines the letter ‘T’ of the ‘Tx’ indicia 118. Other openings (not shown) define other indicia. The electrode 326 is congruently shaped as shown, however need not be.

In operation application of a voltage signal through the elastomeric connector 206, second electrical contact 306, and the second forked trace 316 to the third electrode 326, and through the fifth electrical contact 312, and the transparent conductive layer 408 causes ions to migrate between the ion donor layer 414, and the electrochromic material layer 410 across the electrolyte layer 412, causing the color of the electrochromic material layer 410 underlying the opening 418 to change, and an indicia to be made visible. The indicia is viewed through the transparent plastic shell 402.

According to an alternative embodiment electrodes made from ion donor material are used in lieu of the separate electrodes 322-332, and ion donor material 414.

FIG. 5 is a second fragmentary perspective view of the front housing part 104 shown in FIGS. 1-3. FIG. 5 shows an area of the front housing part 104 that includes the fifth electrical contact 312. Referring to FIG. 5, a second opening 502 is formed through the ion donor layer 414, the electrolyte layer 412, and the electrochromic material layer 410. The insulator layer 416 extends inward into the second opening 502. Within the second opening 502, a third opening 504 is formed in the insulator layer 416. The fifth electrical contact 312 extends through the second 502 and third 504 openings and makes electrical contact with the transparent conductive layer 408. The fifth electrical contact 312 is insulated from the ion donor layer 414, the electrolyte layer 412, and the electrochromic material layer 410 by the insulator layer 416. Note that in contrast to what is shown in FIG. 5 the first through fourth electrical contacts 304-310 are preferably simply supported on a surface 420 of the insulator layer 416. The traces 314-320 are also preferably supported on the surface of the insulator layer 416.

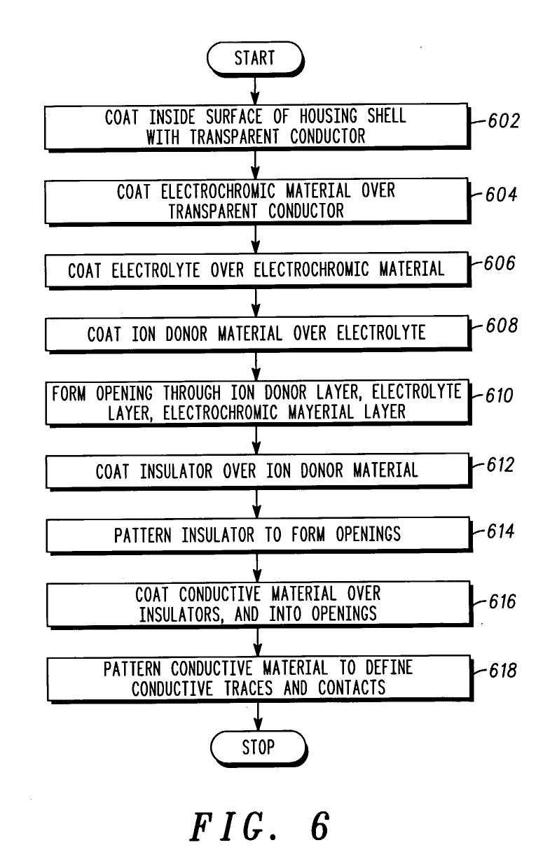

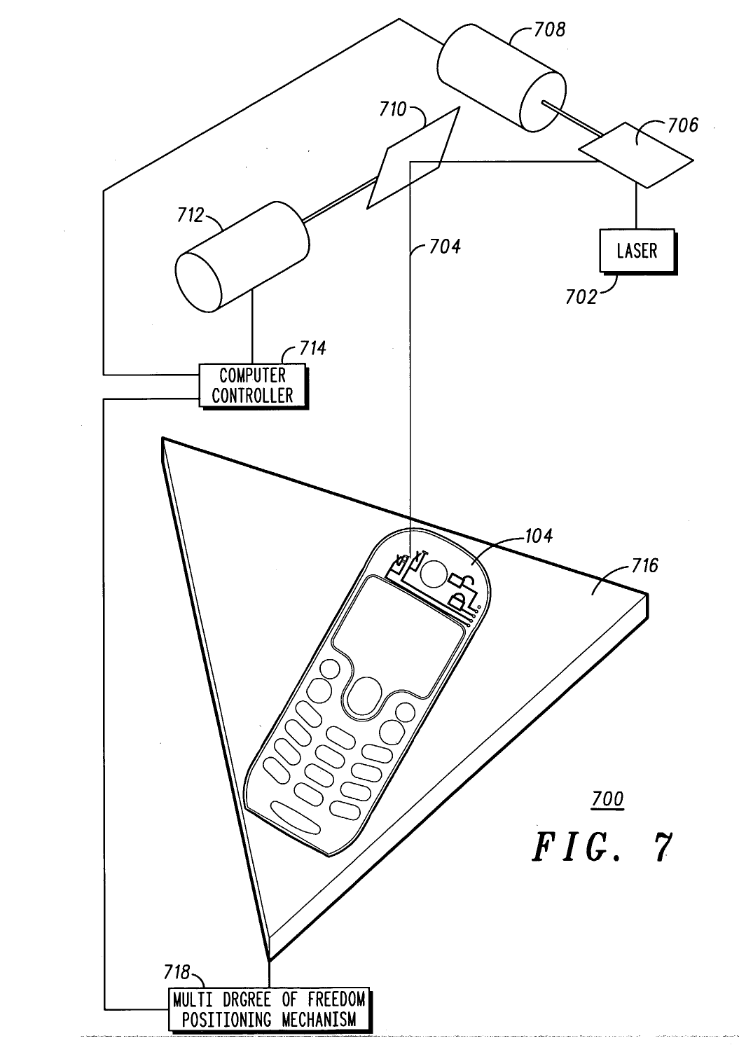

FIG. 6 is a flow chart of a method of fabricating the electrochromic activatable indicia 114-120 in the front housing 104 part shown in FIGS. 1-4. Referring to FIG. 6, in step 602 the inside surface 406 of the plastic shell 402 is coated with the transparent conductive layer 408. In step 604 the electrochromic material layer 410 is coated over the transparent conductive layer 408. In step 606 the electrolyte layer 412 is coated over the electrochromic material layer 410. In step 608 the ion donor layer 414 is coated over the electrolyte layer 412. In step 610 the second opening 502 is formed through the ion donor layer 414, the electrolyte layer 412, and the electrochromic material layer 410. The second opening 502 is preferably formed by laser etching. In step 612 an unpatterned insulator layer is coated over the ion donor layer 414. In step 614 the unpatterned insulator layer is patterned to form the patterned insulator layer 416. The unpatterned insulator layer is preferably patterned using laser etching. The first 418 and third 504 openings are preferably formed in step 614. In step 616 a second conductive layer is formed over the patterned insulator layer 414. Conductive material of the second conductive layer fills openings 418, 504 of the patterned insulator layer 416. The second conductive layer preferably comprises a conductive polymer. Alternatively, the second conductive layer comprises indium-tin-oxide. In step 618 the second conductive layer is patterned to define contacts (e.g., the first through fifth contacts 304-312), traces (e.g., the first through fourth traces 314-320), and the electrodes (e.g., first through sixth electrodes 322-332). The second conductive layer is preferably patterned using laser etching. In using laser etching to form the second openings 502, to pattern the insulator layer 416, and to pattern the conductive layer formed on the insulator layer 416, the depth of etching is controlled by controlling the intensity and/or duration for which a laser is impinged on each area (e.g., through scan rate control), so as not to cut through underlying layer which are not intended to be laser etched.

FIG. 7 is a schematic diagram of a laser etching apparatus 700 for use in the method shown in FIG. 5 according to the preferred embodiment of the invention. The laser etching apparatus comprises a laser 702 that generates a laser beam 704. The laser beam 704 is deflected by a first beam steering mirror 706 that is oriented by a first servo 708, and is subsequently deflected by a second beam steering mirror 710 that is oriented by a second servo 712. An axis of rotation of the first beam steering mirror 706 is perpendicular to an axis of rotation of the second beam steering mirror 710 so that a point of impingement of the laser beam 704 can be controlled in two dimensions (degrees of freedom). The laser beam 704 is shown impinging the front housing part 104 at the end of a process of laser etching the conductive material. The first 708 and second 712 servo motors are controlled by a computer controller 714 based on pattern information stored in the computer controller 714. The front housing part 104 is mounted on stage 716 that is oriented and optionally positioned by a multi-degree of freedom positioning mechanism 718. Employing the stage 716, 718 may facilitate orienting sloped portions of the front housing part toward the laser beam 704. The multi-degree of freedom positioning mechanism 718 is controlled by the computer controller 704. Optionally, the multi-degree of freedom positioning mechanism 718 is not used.

Although embodiments of the invention are described above with reference to a wireless communication device, it will be appreciated by those skilled in the art the teachings described herein above are alternatively applied to devices other than wireless communication devices. As described above the embodiments of the invention allow selectively activatable indicia to be formed on compound curved shaped parts, such as compound curve shaped plastic housing parts.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A device having activatable visual indicia, the device comprising:
a plastic shell comprising a curved surface;
a sequence of layers located on the curved surface, the sequence of layers comprising:
an electrochromic material layer;
an electrolyte layer; and
a first conductive layer.

2. The device according to claim 1 wherein:
the curved surface comprises a compound curved surface.

3. The device according to claim 1 further comprising:
a second conductive layer on an opposite side of the electrochromic material layer from the first conductive layer, wherein the second conductive layer is transparent, and the first conductive layer is patterned to define electrodes, and traces connected to the electrodes.

4. The device according to claim 3 wherein:
the plastic shell is transparent, and the second conductive layer is disposed between the first conductive layer and the plastic shell.

5. The device according to claim 3 further comprising:
a patterned insulator layer that includes openings through which the electrodes penetrate, and wherein the traces are supported on the insulator layer.

6. The device according to claim 1 wherein:
the electrochromic layer is disposed between the first conductive layer and the plastic shell.

7. The device according to claim 1 further comprising:
an ion donor layer disposed between the electrolyte material layer, and the first conductive layer.

8. A device housing comprising:
a transparent plastic shell including a compound curve inside surface;
a sequence of layers located on the inside surface, the sequence of layers comprising:
an electrochromic material layer;
an electrolyte layer; and
a first conductive layer;
wherein the electrochromic material layer is located between the first conductive layer, and the inside surface.

9. A method of fabricating a part with an activatable electrochromic indicia formed on a curved surface of the part, the method comprising the steps of:
forming a sequence of layers including an electrochromic material layer, an electrolyte layer, and a first conductive layer on the curved surface of the part;

10. The method according to claim 10 wherein forming the sequence of layers comprises:
forming the electrochromic material layer over the curved surface of the part;
subsequently forming the electrolyte layer over the electrochromic layer;
subsequently forming the first conductive layer over the electrolyte layer;
the method further comprising:
patterning the first conductive layer to define electrodes.

11. The method according to claim 10 wherein patterning the first conductive layer to define electrodes comprises:
laser etching the first conductive layer.

12. The method according to claim 10 further comprising:
prior to forming the first conductive layer, forming an insulator layer over the electrolyte layer; and
patterning the insulator layer to define openings through the insulator layer to the electrolyte layer for the electrodes.

13. The method according to claim 12 wherein patterning the insulator layer comprises:
laser etching the insulator layer.

14. The method according to claim 12 further comprising:
prior to forming the insulator layer, forming an ion donor material layer, over the electrolyte layer.

15. The method according to claim 10 further comprising:
prior to forming the electrochromic material layer, forming a transparent conductive layer on the curved surface of the part.
